(19) United States
(12) Patent Application Publication
(10) Pub. No.: US 2013/0346636 A1
(43) Pub. Date: Dec. 26, 2013

(54) Interchangeable Surface Input Device Mapping

(71) Applicant: Microsoft Corporation, Redmond, WA (US)

(72) Inventors: Steven Nabil Bathiche, Kirkland, WA (US); Panos C. Panay, Redmond, WA (US); Ralf Groene, Kirkland, WA (US); Hua Wang, Sammamish, WA (US); Timothy C. Shaw, Sammamish, WA (US); David M. Lane, Sammamish, WA (US); Young Soo Kim, Bellevue, WA (US)

(21) Appl. No.: 13/974,994

(22) Filed: Aug. 23, 2013

Related U.S. Application Data
(63) Continuation-in-part of application No. 13/655,065, filed on Oct. 18, 2012.
(60) Provisional application No. 61/659,364, filed on Jun. 13, 2012.

(51) Int. Cl. G06F 13/10

(52) U.S. Cl. CPC G06F 13/102
USPC 710/8

(57) ABSTRACT

An input device with an interchangeable surface is described. In one or more implementations, an input device base includes a connection portion configured to provide a physical and communicative coupling to a computing device and a plurality of sensors configured to initiate respective inputs responsive to contact from a user. The input device also includes an interchangeable surface that is removable and connectable, physically, to the input device base, the interchangeable surface having a plurality of indications of inputs that are to be initiated via respective ones of the plurality of sensors.

### RELATED APPLICATIONS

This application claims priority as a continuation-in-part of U.S. patent application Ser. No. 13/655,065, filed Oct. 18, 2012, and titled “Media Processing Input Device,” which claims priority to U.S. Provisional Patent Application No. 61/659,364, filed Jun. 13, 2012, and titled “Music Blade,” the disclosures of which are hereby incorporated by reference in their entirety.

### BACKGROUND

Mobile computing devices have been developed to increase the functionality that is made available to users in a mobile setting. For example, a user may interact with a mobile phone, tablet computer, or other mobile computing device to check email, surf the web, compose texts, interact with applications, play games, and so on. However, traditional mobile computing devices often employed a virtual keyboard that was accessed using touchscreen functionality of the device. This was generally employed to maximize an amount of display area that may be utilized as part of the computing device.

Use of the virtual keyboard, however, could be frustrating to a user that desired to provide a significant amount of inputs, such as to enter a significant amount of text to compose a long email, document, and so forth. Further, use of portions of the touchscreen functionality could limit an amount of the device that is available to display other data. Thus, conventional mobile computing devices were often perceived to have limited usefulness for such tasks, especially in comparison with ease at which users could enter text using a conventional keyboard, e.g., of a conventional desktop computer.

Use of the conventional keyboards, though, with the mobile computing device could decrease the mobility of the mobile computing device and thus could make the mobile computing device less suited for its intended use in mobile settings. Further, conventional input devices such as a keyboard were dedicated to a single set of functionality, such as a QWERTY keyboard, gesture track pad, and so on. Therefore, users were often forced to collect and maintain a variety of different input devices such as keyboards, numeric keypads, and so on to avail themselves of different functionality if so desired, which could also decrease the mobility of the computing device.

### SUMMARY

An input device with an interchangeable surface is described. In one or more implementations, an input device base includes a connection portion configured to provide a physical and communicative coupling to a computing device and a plurality of sensors configured to initiate respective inputs responsive to contact from a user. The input device also includes an interchangeable surface that is removable and connectable, physically, to the input device base. The interchangeable surface has a plurality of indications of inputs that are to be initiated via respective ones of the plurality of sensors.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ interchangeable surface techniques described herein.

FIG. 2 depicts an example implementation of an input device of FIG. 1 as showing a flexible hinge in greater detail.

FIG. 3 depicts an example implementation of a cross section of the input device of FIG. 2 showing an input device base and interchangeable surface.

FIG. 4 depicts an example of the input device of FIG. 3 showing placement of securing mechanisms configured to removably attach the interchangeable surface to the input device base.

FIG. 5 depicts a system in an example implementation showing configuration of an input device base of an input device to accept a plurality of different interchangeable surfaces.

FIG. 6 depicts examples of an indication of the interchangeable surface of FIG. 5 as disposed over corresponding sensors of the input device base as well as an indication of the interchangeable surface as disposed over corresponding sensors of the input device base.

FIG. 7 is an illustration of an example implementation in which an input device base includes sensors configured in accordance with a QWERTY keyboard over which an interchangeable surface is employed to provide other indications of inputs.

FIG. 8 is an illustration of an example of the input device of FIG. 7 as including an interchangeable surface configured as a game controller.

FIG. 9 depicts a system in an example implementation in which mapping data stored as part of an interchangeable surface is leveraged to map indications of inputs of an interchangeable surface to sensors of an input device base.

FIG. 10 depicts a system in an example implementation in which the input device is configured to map indications of inputs of an interchangeable surface to sensors of an input device base, which are then exposed to the computing device.

FIG. 11 depicts a system in an example implementation in which input device mapping data may be obtained and utilized from a variety of different sources by a variety of different devices.

FIG. 12 depicts another example of the input device as having a plurality of interchangeable surfaces.

FIG. 13 depicts an example of a cross-sectional view of a pressure sensitive key of a keyboard of the input device of FIG. 2.

FIG. 14 depicts an example of the pressure sensitive key of FIG. 13 as having pressure applied at a first location of the flexible contact layer to cause contact of the force sensitive ink with a corresponding first location of the sensor substrate.

FIG. 15 depicts an example of the pressure sensitive key of FIG. 13 as having pressure applied at a second location of the flexible contact layer to cause contact with a corresponding second location of the sensor substrate.

FIG. 16 depicts an example of a pressure sensitive key of FIG. 13 as employing a force concentrator layer.

FIG. 17 an example of the pressure sensitive key of FIG. 13 as having pressure applied at a plurality of different locations of the force concentrator layer to cause the flexible contact layer to contact the sensor substrate.

FIG. 18 illustrates an example of a view of a cross section of a keyboard that includes a plurality of pressure sensitive keys that employ the force concentrator layer.

FIG. 19 depicts a system in an example implementation in which multiple force concentrators are utilized.

FIG. 20 depicts a system in an example implementation in which the interchangeable surface is configured to include mechanical keys.

FIG. 21 depicts a procedure in an example implementation in which an input device having an input device base and interchangeable surface is formed.

FIG. 22 depicts a procedure in an example implementation in which mappings are obtained that are usable to map indications of inputs of an interchangeable surface of an input device to corresponding sensors of an input device base.

FIG. 23 depicts a procedure in an example implementation in which input detected using an input device having an interchangeable surface are translated and exposed to an application of a computing device.

FIG. 24 illustrates an example system generally that includes an example computing device that is representative of one or more computing systems and/or devices that may implement the various techniques described herein.

### DETAILED DESCRIPTION

Overview

Input devices may be configured in a variety of ways to add a wide variety of functionality for use with a computing device. This may include use of specialized functionality that is dedicated to particular tasks, such as for game controllers, music mixing, and so on. However, conventional techniques that were utilized to provide this functionality could involve dedicated hardware, which could be expensive in that a user wishing to use this functionality was forced to purchase a dedicated device having this hardware. Therefore, the expense could often cause users to forgo use of this functionality.

An input device having an interchangeable surface is described. In one or more implementations, an input device includes an input device base that has a plurality of sensors, such as pressure sensitive sensors. An interchangeable surface is connectable physically to the input device and has indications of inputs that are to be initiated by respective sensors. The indications of the inputs of the interchangeable surface are then mapped to one or more sensors of the input device base. For example, an indication of a letter “A” of the interchangeable surface may be mapped to a plurality of underlying sensors. Therefore, when a user presses the indication a computing device may recognize an input from those sensors as the letter “A.” In this way, a variety of different interchangeable surfaces having differing indications may be utilized and mapped to provide a variety of different functionality to a user from a single input device, such as a game controller, music player, keyboard, and so on.

Additionally, through use of pressure sensitive sensors, an amount of pressure may also be indicated as part of an input to support a wide variety of functionality, such as use of a game controller, music device, to weigh a package for a shipping configuration, weigh ingredients for cooking, and so on. In this way, a relatively inexpensive interchangeable surface may be dedicated to support specific input functionality by leveraging an input device base having a plurality of sensors. Thus, the interchangeable surface may be configured for the dedicated functionality without redesigning the input device as a whole, thereby saving time involved in the development of the device as well as money involved in the manufacture of the device.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

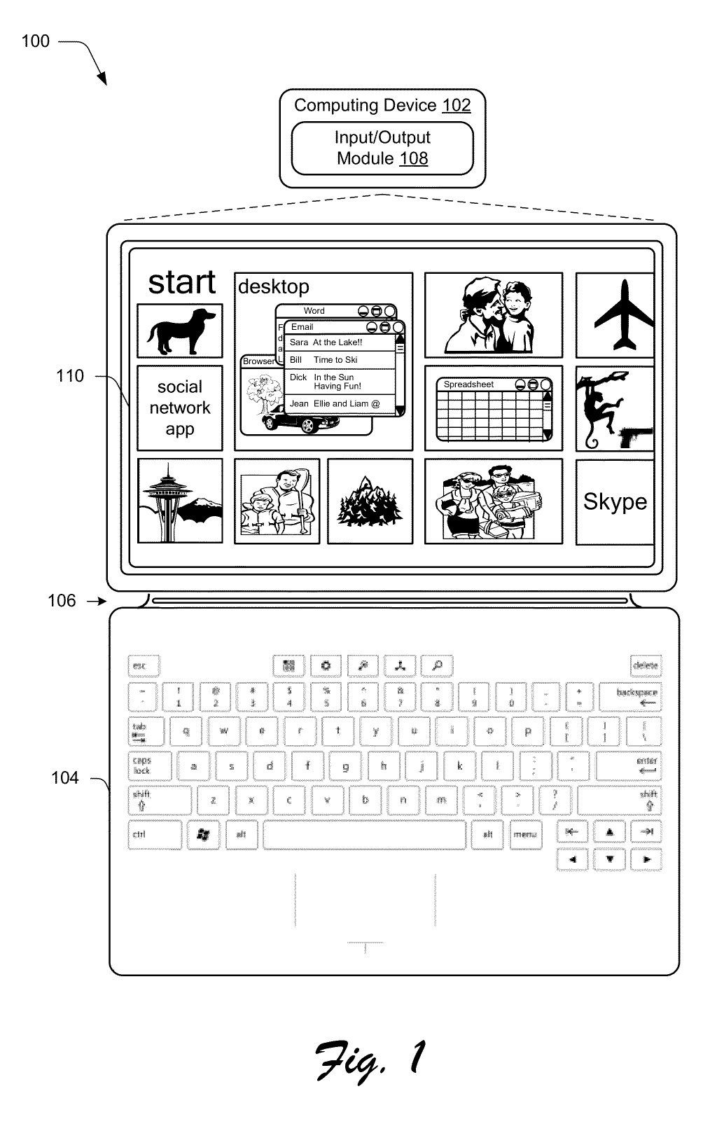

FIG. 1 is an illustration of an environment 100 in an example implementation that is operable to employ the techniques described herein. The illustrated environment 100 includes an example of a computing device 102 that is physically and communicatively coupled to an input device 104 via a flexible hinge 106. The computing device 102 may be configured in a variety of ways. For example, the computing device 102 may be configured for mobile use, such as a mobile phone, a tablet computer having a slate configuration as illustrated, and so on. Thus, the computing device 102 may range from full resource devices with substantial memory and processor resources to a low-resource device with limited memory and/or processing resources, e.g., a music playing device. The computing device 102 may also relate to software that causes the computing device 102 to perform one or more operations.

The computing device 102, for instance, is illustrated as including an input/output module 108. The input/output module 108 is representative of functionality relating to processing of inputs and rendering outputs of the computing device 102. A variety of different inputs may be processed by the input/output module 108, such as inputs relating to functions that correspond to keys or gestures of the input device 104, keys of a virtual keyboard displayed by the display device 110 to identify gestures and cause operations to be performed that correspond to the gestures that may be recognized through the input device 104 and/or touchscreen functionality of the display device 110, and so forth. Thus, the input/output module 108 may support a variety of different input techniques by recognizing and leveraging a division between types of inputs including key presses, gestures, and so on.

In the illustrated example, the input device 104 is configured as a keyboard having a QWERTY arrangement of keys although other arrangements of keys are also contemplated, e.g., support for different languages. Further, other non-conventional configurations are also contemplated, such as a game controller, configuration to mimic a musical instrument, and so forth as further described later in the discussion. Thus, the input device 104 and keys incorporated by the input device 104 may assume a variety of different configurations to support a variety of different functionality.

As previously described, the input device 104 is physically and communicatively coupled to the computing device 102 in this example through use of a flexible hinge 106. The flexible hinge 106 is flexible in that rotational movement supported by the hinge is achieved through flexing (e.g., bending) of the material forming the hinge as opposed to mechanical rotation as supported by a pin, although that embodiment is also contemplated. Further, this flexible rotation may be configured to support movement in one direction (e.g., vertically in the figure) yet restrict movement in other directions, such as lateral movement of the input device 104 in relation to the computing device 102. This may be used to support consistent alignment of the input device 104 in relation to the computing device 102, such as to align sensors used to change power states, application states, and so on.

The flexible hinge 106, for instance, may be formed using one or more layers of fabric and include conductors formed as flexible traces to communicatively couple the input device 104 to the computing device 102 and vice versa. This communication, for instance, may be used to communicate a result of a key press to the computing device 102, receive power from the computing device, perform authentication, provide supplemental power to the computing device 102, and so on. The flexible hinge 106 may be configured in a variety of ways, further discussion of which may be found in relation to the following figure.

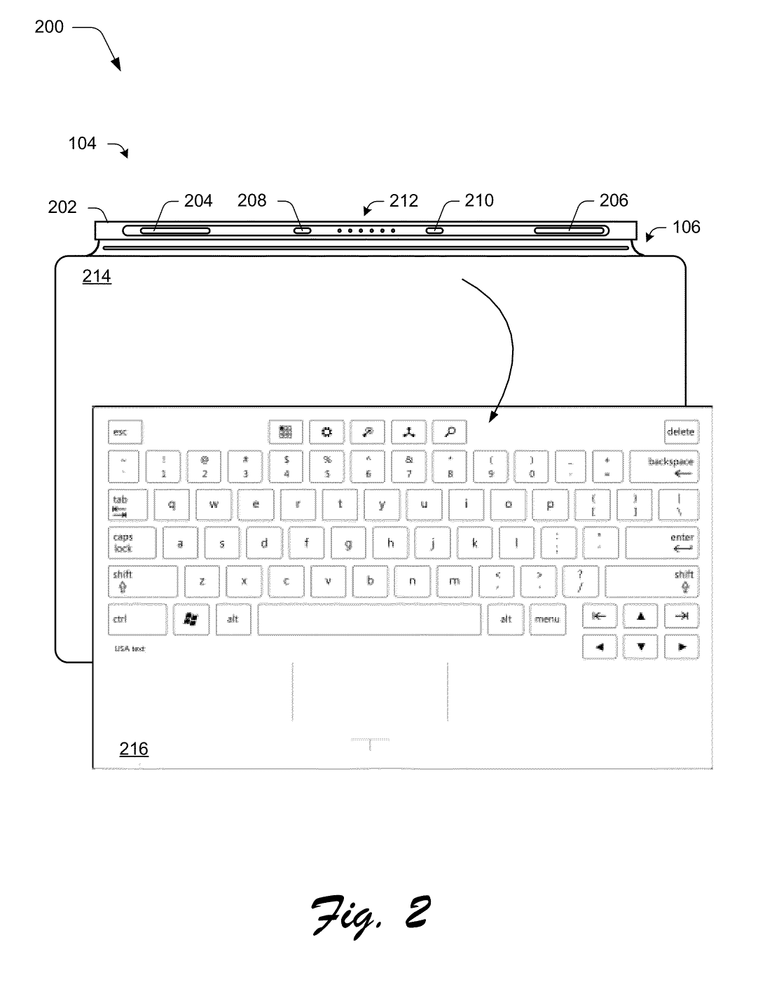

FIG. 2 depicts an example implementation 200 of the input device 104 of FIG. 1 as showing the flexible hinge 106 in greater detail. In this example, a connection portion 202 of the input device 104 is shown as configured to provide a communicative and physical connection between the input device 104 and the computing device 102. In this example, the connection portion 202 has a height and cross section configured to be received in a channel in the housing of the computing device 102, although this arrangement may also be reversed without departing from the spirit and scope thereof.

The connection portion 202 is flexibly connected to a portion of the input device 104 that includes the keys through use of the flexible hinge 106. Thus, when the connection portion 202 is physically connected to the computing device the combination of the connection portion 202 and the flexible hinge 106 supports movement of the input device 104 in relation to the computing device 102 that is similar to a hinge of a book.

For example, rotational movement may be supported by the flexible hinge 106 such that the input device 104 may be placed against the display device 110 of the computing device 102 and thereby act as a cover. The input device 104 may also be rotated so as to be disposed against a back of the computing device 102, e.g., against a rear housing of the computing device 102 that is disposed opposite the display device 110 on the computing device 102.

Naturally, a variety of other orientations are also supported. For instance, the computing device 102 and input device 104 may assume an arrangement such that both are laid flat against a surface as shown in FIG. 1. In another instance, a typing arrangement may be supported in which the input device 104 is laid flat against a surface and the computing device 102 is disposed at an angle to permit viewing of the display device 110, e.g., such as through use of a kickstand disposed on a rear surface of the computing device 102. Other instances are also contemplated, such as a tripod arrangement, meeting arrangement, presentation arrangement, and so forth.

The connecting portion 202 is illustrated in this example as including magnetic coupling devices 204, 206, mechanical coupling protrusions 208, 210, and a plurality of communication contacts 212. The magnetic coupling devices 204, 206 are configured to magnetically couple to complementary magnetic coupling devices of the computing device 102 through use of one or more magnets, e.g., a flux fountain. In this way, the input device 104 may be physically secured to the computing device 102 through use of magnetic attraction. The connecting portion 202 also includes mechanical coupling protrusions 208, 210 to form a mechanical physical connection between the input device 104 and the computing device 102.

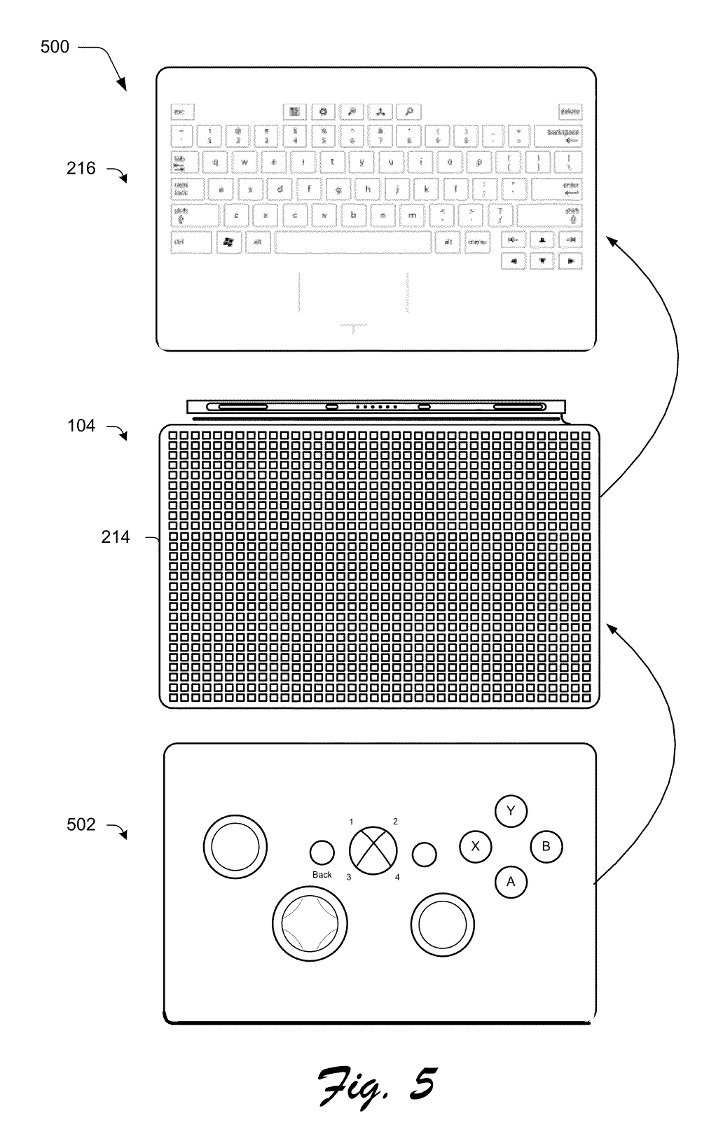

The input device 104 as illustrated includes an input device base 214 and an interchangeable surface 216. The interchangeable surface 216 is configured to be removable from the input device base 214 such that the interchangeable surface 216 may be replaced with another interchangeable surface as shown in FIG. 5. For example, the input device base 214 may include a backlight (e.g., LEDs) that are configured to shine through the interchangeable surface to show different indications of inputs based on configuration of the interchangeable surface 216. In this way, functionality of the input device 104 itself may also be changed through configuration of the interchangeable surface 216. Thus, rather than offer different specifically configured input devices 104, which may be relatively expensive, an inexpensive interchangeable surface 216 may be produced and leveraged in a wide variety of ways.

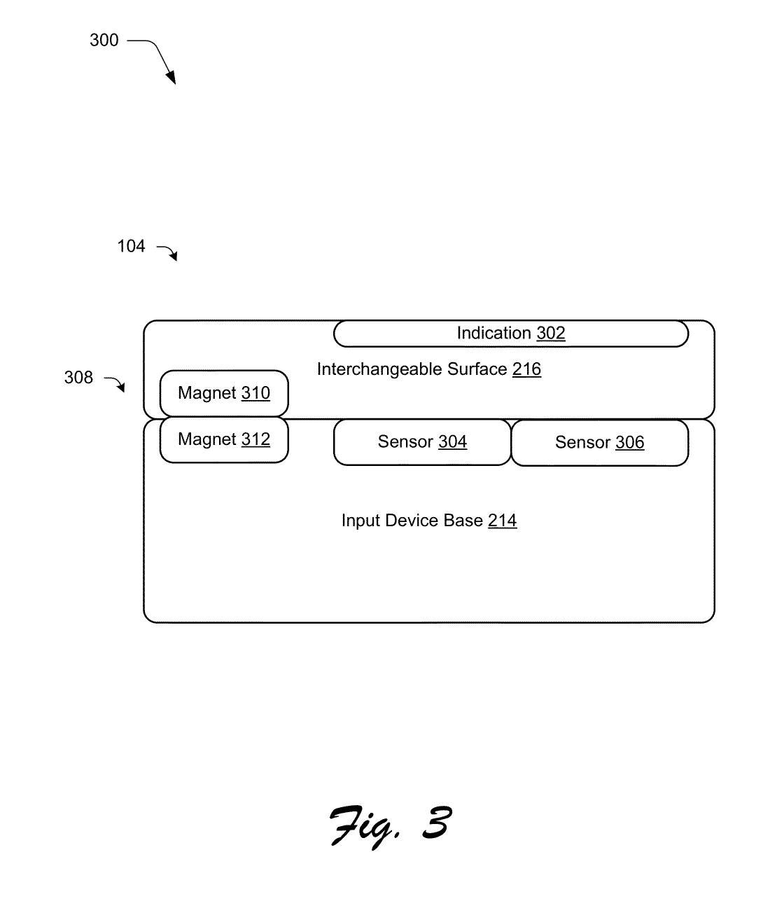

FIG. 3 depicts an example implementation 300 of a cross section of the input device 104 of FIG. 2 showing the input device base 214 and interchangeable surface 216. In this example, the interchangeable surface 216 is illustrated as including an indication 302 of an input that is to be initiated by a user, such as through contact by a finger of a user's hand, a stylus, placement of an object, and so on. The indication 302 may take a variety of forms, such as a particular key (e.g., an alphanumeric key), functionality (e.g., slider control, track pad, radial dial, weighing device), and so forth.

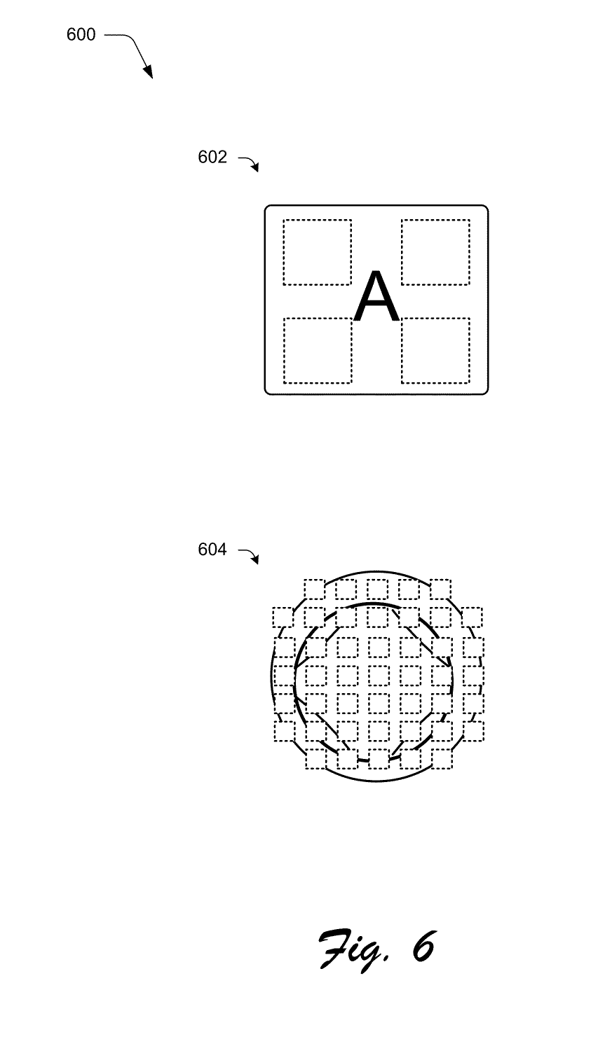

Sensors 304, 306 that are usable to detect this input are disposed as part of the input device base 214. Thus, different indications of inputs may be provided through use of different interchangeable surfaces 216 with the input device base 214. The indications 302 may then be mapped to one or more of the sensors 304, 306 such that the computing device 102 may recognize the indicated inputs as further described beginning in relation to FIG. 6.

The interchangeable surface 216 is illustrated as being removably secured to the input device base 214 through use of a securing mechanism 308. In the illustrated instance, the securing mechanism 308 employs one or more magnets 310, 312 that may be configured in a variety of ways (e.g., a flux fountain) to attach the interchangeable surface 216 to the input device base 214, e.g., to “click” it into place.

Although described through the use of magnets in this example, the securing mechanism 308 may be configured in a variety of other ways. For instance, the securing mechanism 308 may include a raised border that is configured to fit into a complimentary slot to aid mechanical alignment and securing of the base and surface to each other. In another example, electrostatic techniques may be employed to secure the interchangeable surface 216 to the input device base 214 using chemicals such that a static charge may be used to bond positive and negative complimentary portions to each other. A variety of other examples are also contemplated, such as a mechanical locking device.

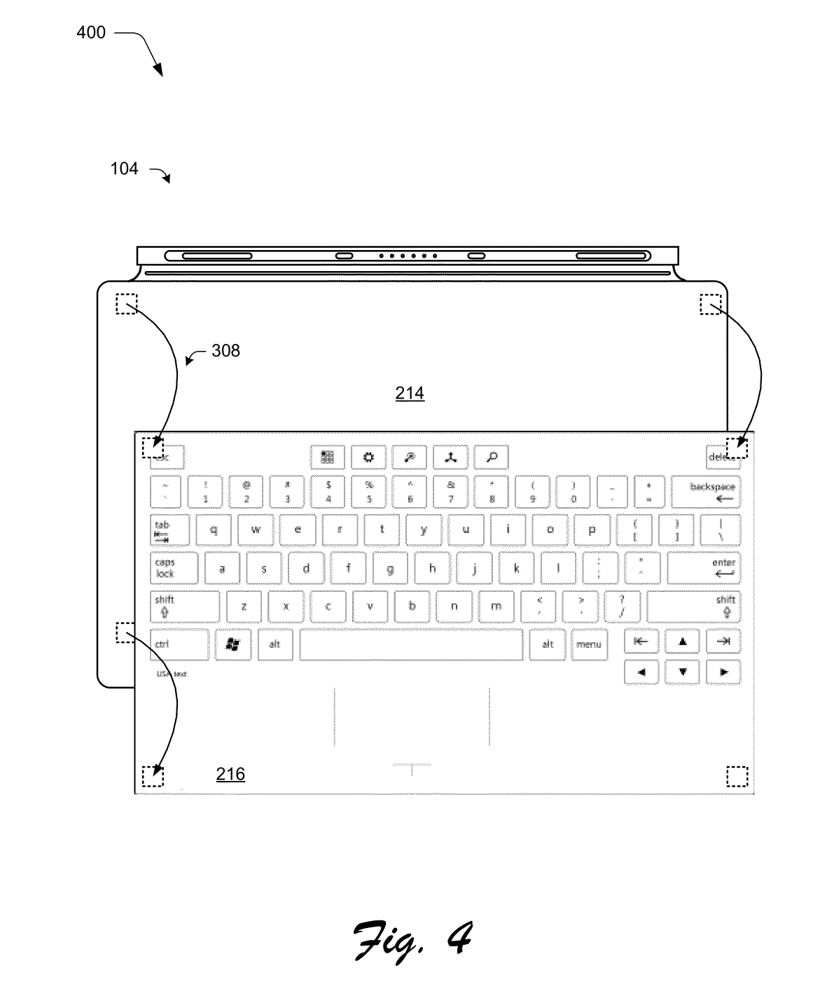

FIG. 4 depicts an example 400 of the input device 104 of FIG. 3 showing placement of securing mechanisms 308 configured to removably attach the interchangeable surface 216 to the input device base 214. In this example, a plurality of the securing mechanisms 308 are illustrated in phantom that are configured to support removable and replaceable attachment of a variety of different interchangeable surfaces 216 to the input device base 214 of the input device 204.

As previously described in relation to FIG. 3, the securing mechanism 308 may be configured in a variety of ways to support this attachment, such as mechanical, electrostatic, magnetic, and so on. Sensors utilized to detect contact received via the interchangeable surface may be configured in a variety of ways, an example of which is described as follows and shown in a corresponding figure.

FIG. 5 depicts a system 500 in an example implementation showing configuration of an input device base 216 of an input device 104 to accept a plurality of different interchangeable surfaces 216, 502. In this example, an interchangeable surface 216 configured as a QWERTY keyboard is illustrated as being removed from the input device base 214. An interchangeable surface 502 configured as a game controller is also illustrated as being attached to the input device 214. Thus, as shown in this example the inputs and corresponding functionality supported by the interchangeable surfaces 216, 502 may vary greatly.

Accordingly, the input device base 214 may be configured in a variety of ways to support these differences. In the illustrated example, the input device base 214 includes an array of sensors spaced in a generally uniform manner, e.g., individual sensors placed approximately five millimeters apart on center in a grid arrangement. The sensors are illustrated as squares in the example although other sizes and arrangements are also contemplated, such as staggered generally circular sensors and so on. Further, the sensors may be configured in a variety of ways, such as pressure sensitive sensors, as a capacitive grid, and so on. Regardless of how implemented, one or more of the sensors of the input device base 214 may thus correspond to indications of inputs of the interchangeable surface, further discussion of which is described as follows and shown in a corresponding figure.

FIG. 6 depicts examples of an indication 602 of the interchangeable surface 216 of FIG. 5 as disposed over corresponding sensors of the input device base 214 as well as an indication 604 of the interchangeable surface 502 as disposed over corresponding sensors of the input device base 214. The indication 602 taken from the interchangeable surface 216 configured as a QWERTY keyboard is of an input for a letter “A.”

Once the interchangeable surface 216 is physically attached to the input device base 214, the indication 602 is disposed over four sensors of the input device base, which are illustrated in phantom. Accordingly, a mapping may be employed such that an output from any, all, or a combination thereof of these sensors is recognized by the computing device 102 as the indicated input, e.g., a key press of the letter “A.”

Likewise, the indication 604 taken from the interchangeable surface 502 configured as a game controller is of an input for a rocker control, such as to provide inputs to control direction of an object in a game. Once the interchangeable surface 502 is physically attached to the input device base 214, the indication 604 is also disposed over a plurality of sensors of the input device base 214, which are illustrated in phantom. Accordingly, a mapping may be employed such that an output from any, all, or a combination thereof of these sensors is recognized by the computing device 102 as the indicated input, e.g., different directions dependent on which part of the rocker control receives contact.

Additionally, techniques may be employed to detect a centroid of a contact to determine a likely intent of a contact received by a user. For the indication of the rocker control, for instance, a centroid of a user's finger may be detected to determine a likely direction. This technique may also be employed to determine which of a plurality of indications likely correspond to an input, such as when a user contacts a border between multiple indications the centroid may be used to determine which indication and corresponding sensor is likely intended as an input by a user. Although a uniform array of sensors was described, other arrangements may also be employed that are not uniform, an example of which is described as follows and shown in a corresponding figure.

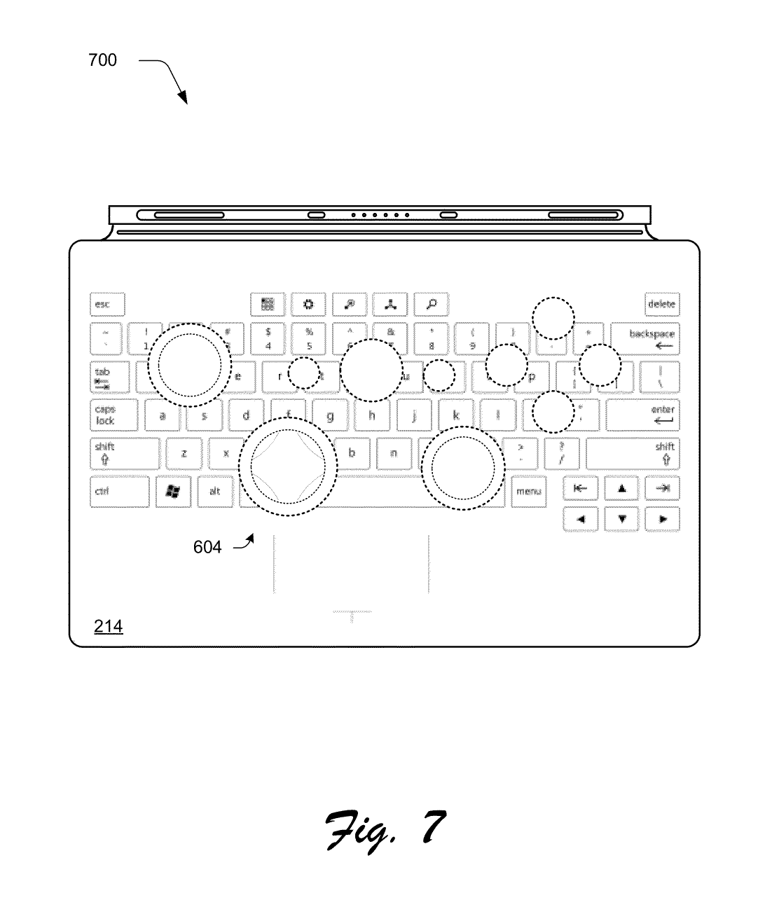

FIG. 7 is an illustration of an example implementation 700 in which an input device base 214 includes sensors configured in accordance with a QWERTY keyboard over which an interchangeable surface is employed to provide other indications of inputs. In this example the input device base 214 includes sensors configured to implement a QWERTY keyboard. Indications of inputs from an interchangeable surface are shown in phantom as disposed over the sensors. Thus, different indications of inputs of the interchangeable surface correspond to one or more keys of the keyboard and corresponding sensors of those keys.

For example, the rocker control 604 may correspond to a combination of letter keys as well as part of the space bar. Accordingly, those keys may be mapped to correspond to the rocker control. Similar techniques may also be employed to map other indications of the game controller to keys of the keyboard and thus corresponding sensors of the input device base 214.

Thus, in this example a user may purchase an input device 104 configured as a keyboard as shown in FIG. 1 and use an interchangeable skin to convert the keyboard into a game controller as shown in the example implementation 800 of FIG. 8. Mappings may then be employed to support correspondence of indications to sensors such that a computing device 102 may recognize the indicated inputs. A variety of different techniques may be employed to implement the mappings, examples of which are described as follows and shown in corresponding figures.

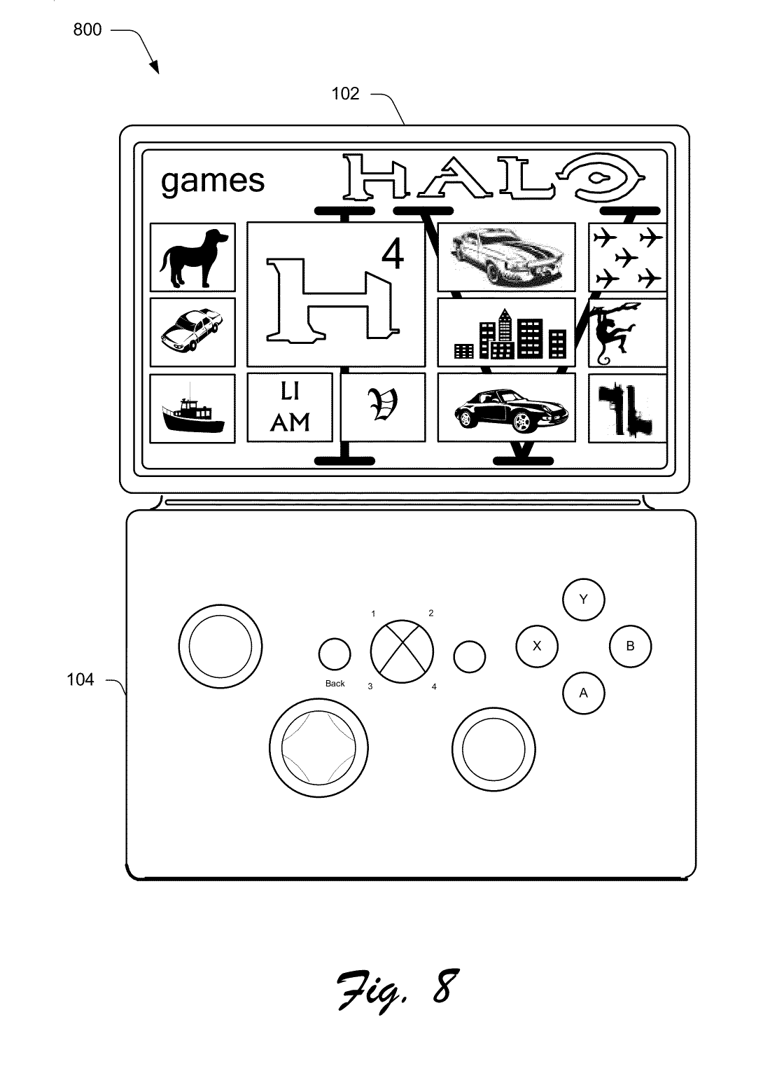

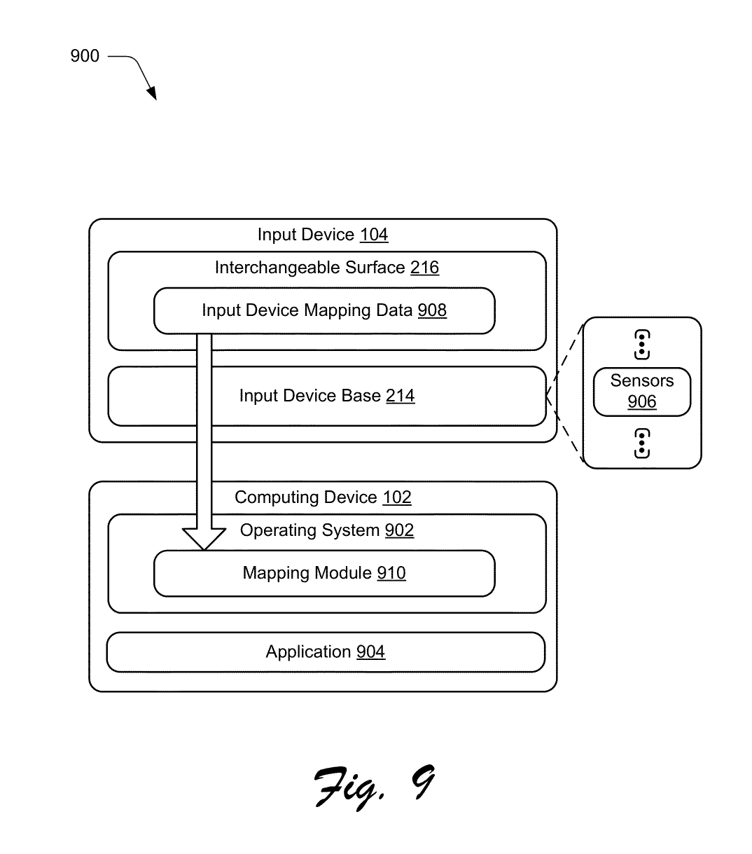

FIG. 9 depicts a system 900 in an example implementation in which mapping data stored as part of an interchangeable surface 216 is leveraged to map indications of inputs of an interchangeable surface 216 to sensors of an input device base 214. The computing device 102 is illustrated as including an operating system 902 and application 904. The operating system 902 is operable to abstract underlying hardware functionality of the computing device 102 to the application 904 such that the application 904 is not “aware” of particular hardware functionality of the computing device 102.

The input device 104 includes the interchangeable surface 216 and the input device base 214 having a plurality of sensors 906 as before. The interchangeable surface 216 in this instance is also illustrated as including input device mapping data 902. The input device mapping data 902 is representative of data that is usable to map indications of inputs of the interchangeable surface 216 to particular sensors 906 of the input device base 214, which may include a size (e.g., to one or more sensors) as well as an arrangement of the indications, one to another. As such, the input device mapping data 908 may take a variety of different forms.

For example, the input device mapping data 908 may include data that describes the actual mappings, themselves, that are stored locally at the interchangeable surface 216. Thus, in this example the input device mapping data 908 describes which inputs correspond to particular sensors of the input device base 214. Therefore, the input device mapping data 908 may be read by the input device base 214 and “passed through” to the operating system 902 for use by a mapping module 910.

The mapping module 910 is representative of functionality to map outputs of particular sensors of the input device base 214 to inputs indicated by the interchangeable surface 216. Thus, in this example the input device mapping data 908 may be employed by the mapping module 910 of the operating system 902 to expose the inputs to the application 904 without the application 904 being made aware of the interchangeable surface 216 and the mappings.

This may be performed in a variety of ways. For example, the mapping may be configured as a spatial map that is usable by a driver layer of the computing device 102. The driver layer may therefore act as a hardware translation layer to apply the mapping, such as to translate X/Y coordinates from sensors 906 of the input device base 214 to corresponding inputs, which may be indicated by the interchangeable surface 216, e.g., formed as part of an outer layer. For instance, the driver layer may translate X/Y coordinates to HID commands that are recognizable by software of the computing device 102, e.g., the operating system 902, application 904, and so on.

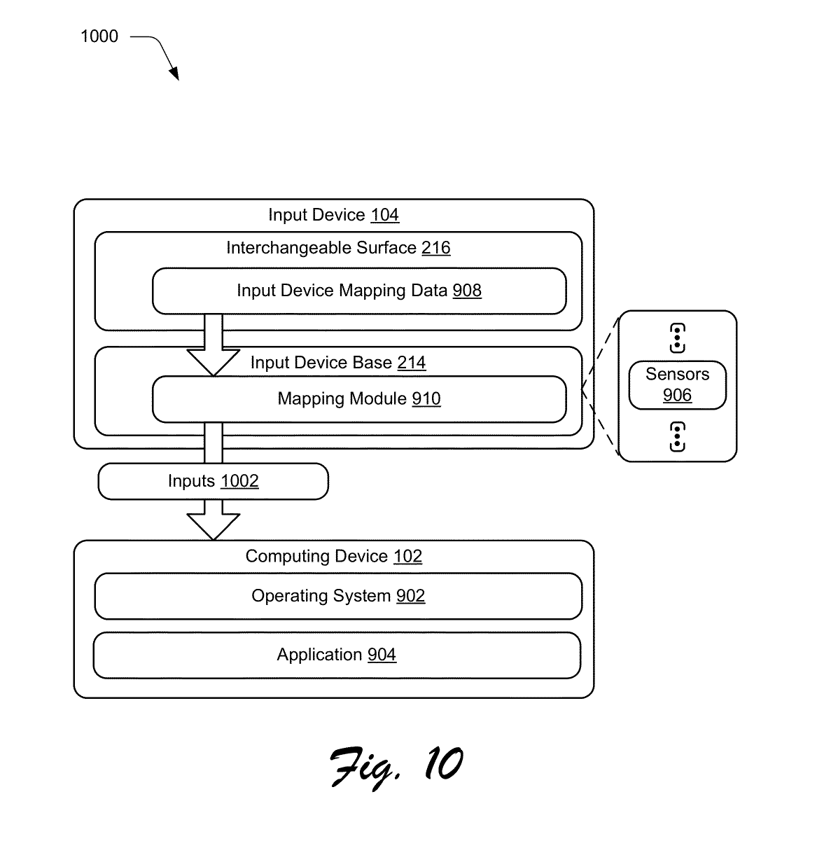

FIG. 10 depicts a system 1000 in an example implementation in which the input device 104 is configured to map indications of inputs of an interchangeable surface 216 to sensors of an input device base 214, which are then exposed to the computing device 102. The computing device 102 includes the operating system 902 and application 904 as before. Likewise, the interchangeable surface 216 includes input device mapping data 908.

However, in this example the input device base 214 includes the mapping module 910 that is configured to map the sensors 906 to indications of inputs of the interchangeable surface 216. Thus, in this example the input device 104 is configured to expose inputs 1002 to the computing device 102 such that neither the operating system 902 nor the application 904 is aware of the mapping or even the interchangeable surface 216. Other examples are also contemplated, such as through incorporation of the mapping module 910 as part of the interchangeable surface 216, itself. Although storage of the mappings was described as performed locally by the interchangeable surface, this storage as well as the configuration of the data itself may be implemented in a variety of ways, an example of which is described as follows and shown in a corresponding figure.

FIG. 11 depicts a system 1100 in an example implementation in which input device mapping data may be obtained and utilized from a variety of different sources by a variety of different devices. In the previous example, the input device mapping data 908 is stored locally at the interchangeable surface 216. Other examples are also contemplated. For instance, the input device mapping data 908 of the interchangeable surface 216 may be configured as an identifier that is recognizable by the input device base 214 and/or the computing device 102.

The identifier may then be utilized to obtain the mappings of the indications to the sensors, such as from a service provider 1102 that is accessible via a network 1104 by the computing device 102. The service provider 1102 may include a service manager module 1106 that is representative of functionality to manage and expose the mappings. For instance, the computing device 102 may communicate the identifier via the network 1104 to the service provider 1102. The service manager module 1106 may then utilize the identifier to locate mappings (e.g., a spatial map which assigns inputs including areas of functions to particular sensors) which may then be communicated back over the network 1104 to the computing device 102 to perform the mappings as previously described.

The identifier may be recognized by the input device base 214 and/or the computing device 102 in a variety of ways. For example, the identifier may be stored persistently as part of the interchangeable surface 216 and read by the input device 214 through optical (e.g., barcode), physical communicative (e.g., a wired connection), wireless (e.g., an RFID tag), and so forth. For instance, electrical pogo-like pins may be used by the input device base 214 to leverage an encoded spatial electrical barcode included as part of the interchangeable surface 216. One of the pins may be configured as a ground/signal with other spatial slots having either a metal mark connected or not connected to ground, e.g., a float, that are recognizable as the barcode.

Optical techniques may also be used in which the input device base 214 includes a photo-detector that is modulated in an analog fashion by spatial structures on the interchangeable surface 216. Magnetic techniques may also be employed, similar to the electrical pogo pin example above, with the pins replaced by Hall Effect sensors and the electrical strips replaced with magnets. Physical techniques may also be employed in which the electrical strips on the interchangeable surface 216 are replaced with mechanical pits/dents and the pogo pins are replaced with displacement sensors. Thus, the interchangeable surface 216 and corresponding functionality to be implemented as part of the interchangeable surface 216 may be recognized in a variety of ways.

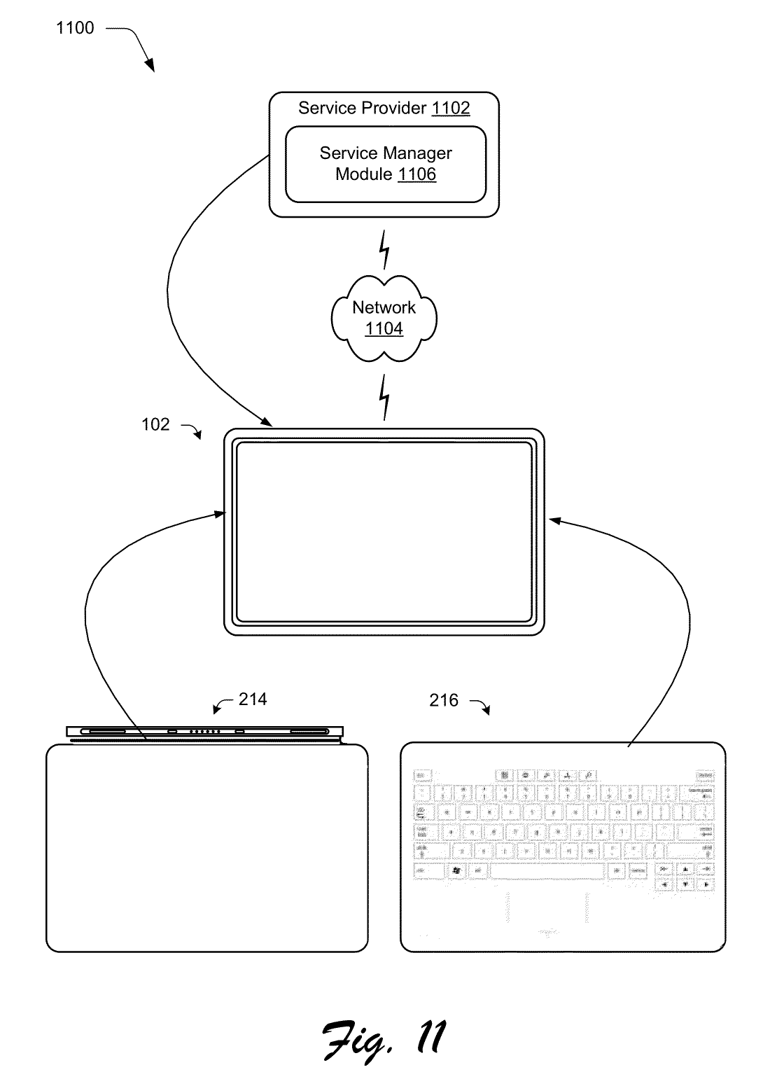

FIG. 12 depicts another example 1200 of the input device 104 as having a plurality of interchangeable surfaces. In the previous examples, a single interchangeable surface 216 was attached to the input device base 214. In the illustrated example 1200 of FIG. 12, however, a plurality of interchangeable skins 1202, 1204 are connected to the input device base 214 simultaneously.

As such, in this example a user may customize different portions of the input device 104 with different functionality, with the corresponding inputs and functionality being recognized as described earlier. Thus, a user may select a game controller and numeric keypad as illustrated or other functionality. Other examples are also contemplated, such as a music DJ interchangeable surface that has a dedicated layout for tracks, beats, and mixing. In another example, a pencil interchangeable surface may be configured to support a paper-like experience.

As previously described, the sensors may be configured in a variety of ways, including pressure sensitive sensors. Accordingly, an input received from the sensors may also indicate an amount of pressure, which may be leveraged to support a variety of different functionality. For example, the amount of pressure may be leverage by a game controller or music DJ configuration. The amount of pressure may also be leveraged as part of a “shipping” configuration, such as to weigh a package, as part of a cooking configuration to weigh ingredients, and so forth. Thus, the interchangeable skins may be configured in a variety of different ways. Examples of pressure sensitive sensors that may be utilized as part of the input device base 214 are described as follows and shown in a corresponding figure.

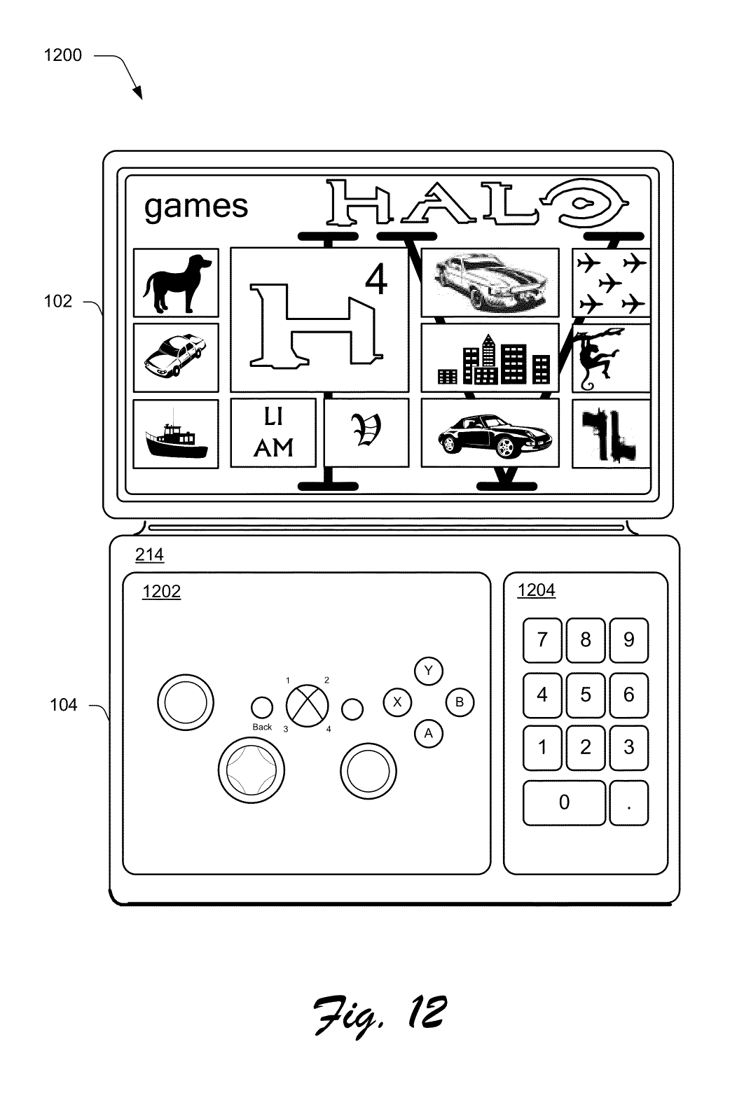

FIG. 13 depicts an example of a cross-sectional view of a pressure sensitive key 1300 of a keyboard of the input device 104 of FIG. 2. The pressure sensitive key 1300 in this example is illustrated as being formed using a flexible contact layer 1302 (e.g., Mylar) that is spaced apart from the sensor substrate 1304 using a spacer layer 1306, 1308, which may be formed as another layer of Mylar or other bendable material, formed on the sensor substrate 1304, and so on. In this example, the flexible contact layer 1302 does not contact the sensor substrate 1304 absent application of pressure against the flexible contact layer 1302, e.g., received via contact from a user, e.g., a user's finger, weight of a package placed by the user, and so on.

The flexible contact layer 1302 in this example includes a force sensitive ink 1310 disposed on a surface of the flexible contact layer 1302 that is configured to contact the sensor substrate 1304. The force sensitive ink 1310 is configured such that an amount of resistance of the ink varies directly in relation to an amount of pressure applied. The force sensitive ink 1310, for instance, may be configured with a relatively rough surface that is compressed against the sensor substrate 1304 upon an application of pressure against the flexible contact layer 1302. The greater the amount of pressure, the more the force sensitive ink 1310 is compressed, thereby increasing conductivity and decreasing resistance of the force sensitive ink 1310. Other conductors may also be disposed on the flexible contact layer 1302 without departing form the spirit and scope therefore, including other types of pressure sensitive and non-pressure sensitive conductors.

The sensor substrate 1304 includes one or more conductors 1312 disposed thereon that are configured to be contacted by the force sensitive ink 1310 of the flexible contact layer 1302. When contacted, an analog signal may be generated for processing by the input device 104 and/or the computing device 102, e.g., to recognize whether the signal is likely intended by a user to provide an input for the computing device 102. A variety of different types of conductors 1312 may be disposed on the sensor substrate 1304, such as formed from a variety of conductive materials (e.g., silver, copper), disposed in a variety of different configurations such as inter-digitated trace fingers, and so on.

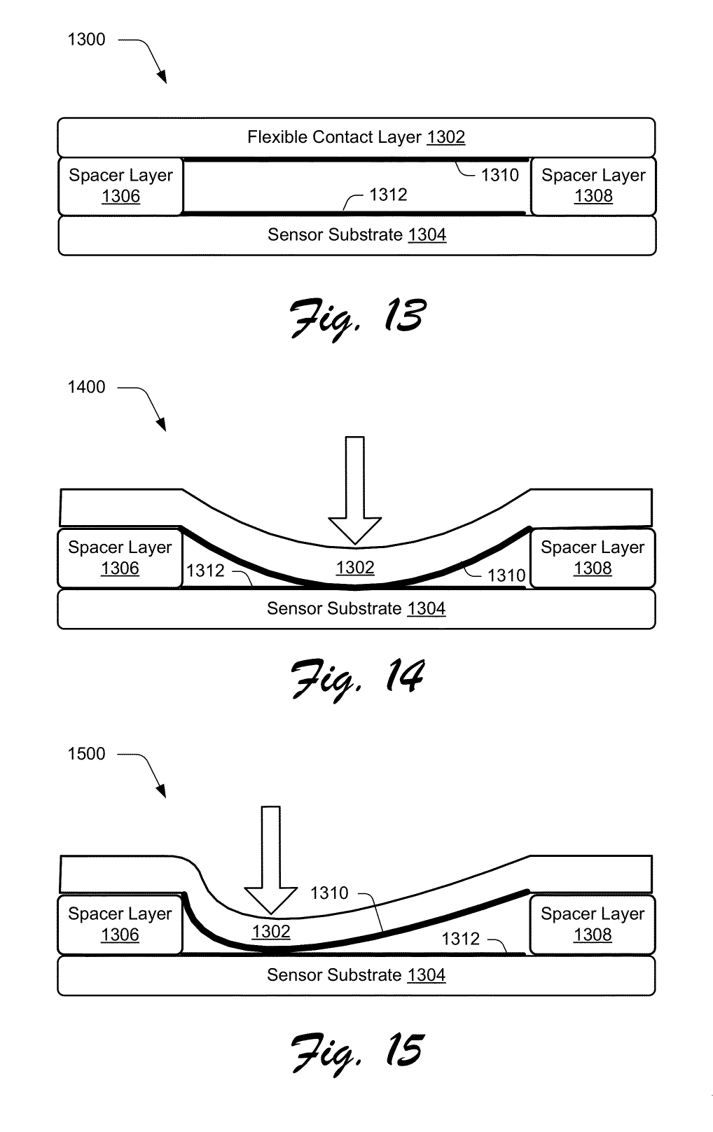

FIG. 14 depicts an example 1400 of the pressure sensitive key 1300 of FIG. 4 as having pressure applied at a first location of the flexible contact layer 1302 to cause contact of the force sensitive ink 1310 with a corresponding first location of the sensor substrate 1304. The pressure is illustrated through use of an arrow in FIG. 14 and may be applied in a variety of ways, such as by a finger of a user's hand, stylus, pen, and so on. In this example, the first location at which pressure is applied as indicated by the arrow is located generally near a center region of the flexible contact layer 1302 that is disposed between the spacer layers 1306, 1308. Due to this location, the flexible contact layer 1302 may be considered generally flexible and thus responsive to the pressure.

This flexibility permits a relatively large area of the flexible contact layer 1302, and thus the force sensitive ink 1310, to contact the conductors 1312 of the sensor substrate 1304. Thus, a relatively strong signal may be generated. Further, because the flexibility of the flexible contact layer 1302 is relatively high at this location, a relatively large amount of the force may be transferred through the flexible contact layer 1302, thereby applying this pressure to the force sensitive ink 1310. As previously described, this increase in pressure may cause a corresponding increase in conductivity of the force sensitive ink and decrease in resistance of the ink. Thus, the relatively high amount of flexibility of the flexible contact layer at the first location may cause a relatively stronger signal to be generated in comparison with other locations of the flexible contact layer 1302 that located closer to an edge of the key, an example of which is described in relation to the following figure.

FIG. 15 depicts an example 1500 of the pressure sensitive key 1300 of FIG. 13 as having pressure applied at a second location of the flexible contact layer 1302 to cause contact with a corresponding second location of the sensor substrate 1304. In this example, the second location of FIG. 15 at which pressure is applied is located closer to an edge of the pressure sensitive key (e.g., closer to an edge of the spacer layer 1306) than the first location of FIG. 14. Due to this location, the flexible contact layer 1302 has reduced flexibility when compared with the first location and thus less responsive to pressure.

This reduced flexibility may cause a reduction in an area of the flexible contact layer 1302, and thus the force sensitive ink 1310, that contacts the conductors 1312 of the sensor substrate 1304. Thus, a signal produced at the second location may be weaker than a signal produced at the first location of FIG. 14.

Further, because the flexibility of the flexible contact layer 1302 is relatively low at this location, a relatively low amount of the force may be transferred through the flexible contact layer 1302, thereby reducing the amount of pressure transmitted to the force sensitive ink 1310. As previously described, this decrease in pressure may cause a corresponding decrease in conductivity of the force sensitive ink and increase in resistance of the ink in comparison with the first location of FIG. 14. Thus, the reduced flexibility of the flexible contact layer 1302 at the second location in comparison with the first location may cause a relatively weaker signal to be generated. Further, this situation may be exacerbated by a partial hit in which a smaller portion of the user's finger is able to apply pressure at the second location of FIG. 6 in comparison with the first location of FIG. 14.

Accordingly, a variety of different techniques may be employed to normalize the inputs, such as varying amounts of the ink at different locations, size and density of conductors 1312, and so on. One such example includes use of a force concentrator layer, which may be employed to improve consistency of the contact of the flexible contact layer 1302 with the sensor substrate 1304 as well as other features, further discussion of which may be found in relation to the following figure.

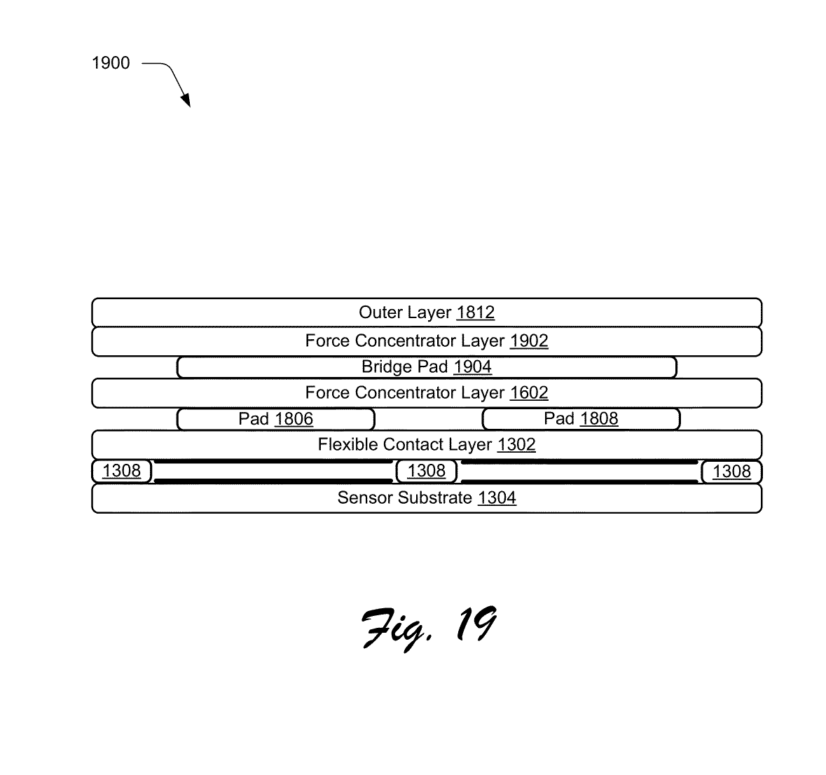

FIG. 16 depicts an example 1600 of a pressure sensitive key of FIG. 13 as employing a force concentrator layer 1602. The force concentrator layer 1602 may be implemented in a variety of ways, such as part of the input device base 214 or the interchangeable surface 216. Additionally, multiple force concentrator layers may be employed as shown in FIG. 19.

The force concentrator layer 1602 may also be configured from a variety of materials, such as a flexible material (e.g., Mylar) that is capable of flexing against the flexible contact layer 1302. The force concentrator layer 1602 in this instance includes a pad 1604 disposed thereon that is raised from a surface of the force concentrator layer 1602. Thus, the pad 1604 is configured as a protrusion to contact the flexible contact layer 1302. The pad 1604 may be formed in a variety of ways, such as formation as a layer (e.g., printing, deposition, forming, etc.) on a substrate of the force concentrator layer 1602 (e.g., Mylar), as an integral part of the substrate itself, and so on.

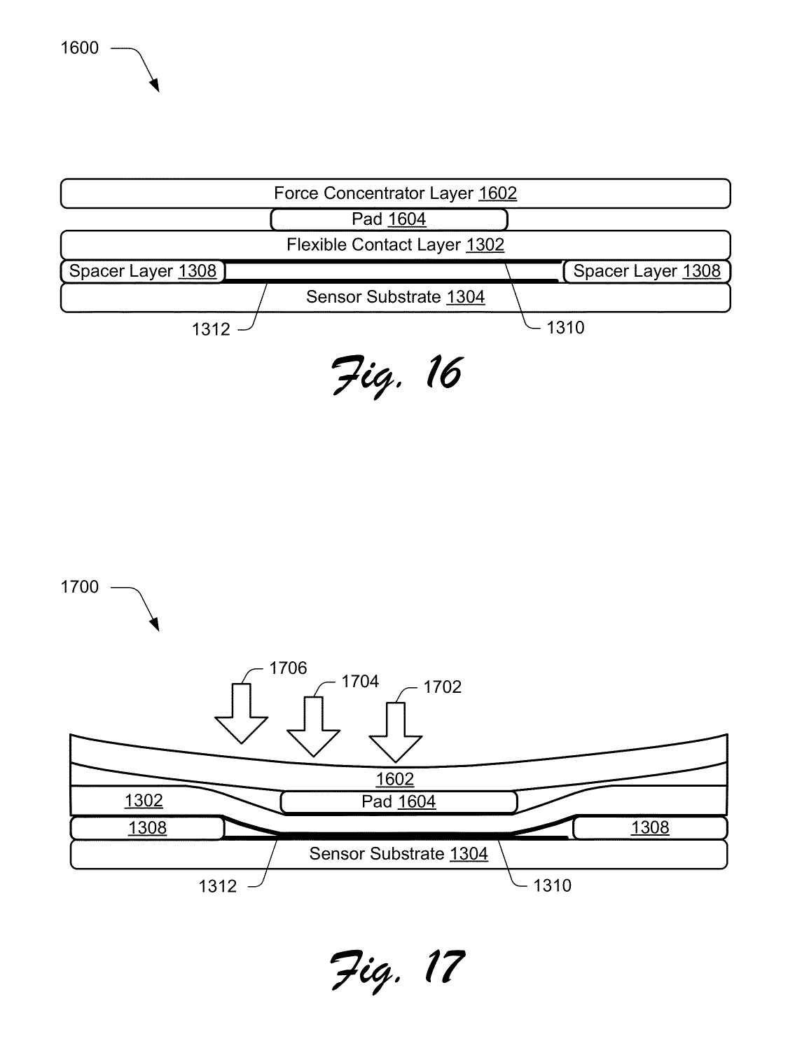

FIG. 17 an example 1700 of the pressure sensitive key 1300 of FIG. 13 as having pressure applied at a plurality of different locations of the force concentrator layer 1602 to cause the flexible contact layer 1302 to contact the sensor substrate 1304. The pressure is again illustrated through use of arrow, which in this instance include first, second, and third locations 1702, 1704, 1706 which are positioned at distances that are respectively closer to an edge of the key, e.g., an edge defined by the spacer layer 1306, 1308.

As illustrated, the pad 1604 is sized so as to permit the flexible contact layer 1302 to flex between the spacer layer 1306, 1308. The pad 1604 is configured to provide increased mechanical stiffness and thus improved resistance to bending and flexing, e.g., as in comparison with a substrate (e.g., Mylar) of the force concentrator layer 1602. Therefore, when the pad 1604 is pressed against the flexible contact layer 1302, the flexible contact layer 1302 has a decreased bend radius as is illustrated through comparison of FIG. 17 with FIGS. 14 and 15.

Thus, the bending of the flexible contact layer 1302 around the pad 1604 may promote a relatively consistent contact area between the force sensitive ink 1310 and the conductors 1312 of the sensor substrate 1304. This may promote normalization of a signal produced by the key as described earlier.

The pad 1604 may also act to spread a contact area of a source of the pressure. A user, for example, my press against the force concentrator layer 1602 using a fingernail, a tip of a stylus, pen, or other object that has a relatively small contact area. As previously described this could result in correspondingly small contact area of the flexible contact layer 1302 that contacts the sensor substrate 1304, and thus a corresponding decrease in signal strength.

However, due to the mechanical stiffness of the pad 1604, this pressure may be spread across an area of the pad 1604 that contacts the flexible contact layer 1302, which is then spread across an area of the flexible contact layer 1302 that correspondingly bends around the pad 1604 to contact the sensor substrate 1304. In this way, the pad 1604 may be used to normalize a contact area between the flexible contact layer 1302 and the sensor substrate 1304 that is used to generate a signal by the pressure sensitive key.

The pad 1604 may also act to channel pressure, even if this pressure is applied “off center.” As previously described in relation to FIGS. 14 and 15, the flexibility of the flexible contact layer 1302 may depend at least partially on a distance from an edge of the pressure sensitive key, e.g., an edge defined by the spacer layer 1306, 1308 in this instance.

The pad 1604, however, may be used to channel pressure to the flexible contact layer 1302 to promote relatively consistent contact. For example, pressure applied at a first location 1702 that is positioned at a general center region of the force concentrator layer 1602 may cause contact that is similar to contact achieved when pressure applied at a second location 804 that is positioned at an edge of the pad 1604. Pressures applied outside of a region of the force concentrator layer 1602 defined by the pad 1604 may also be channeled through use of the pad 1604, such as a third position 806 that is located outside of the region defined by the pad 1604 but within an edge of the key. A position that is located outside of a region of the force concentrator layer 1602 defined by the spacer layer 1306, 1308 may also be channeled to cause the flexible contact layer 1302 to contact the sensor substrate 1304, an example of which is defined in relation to the following figure.

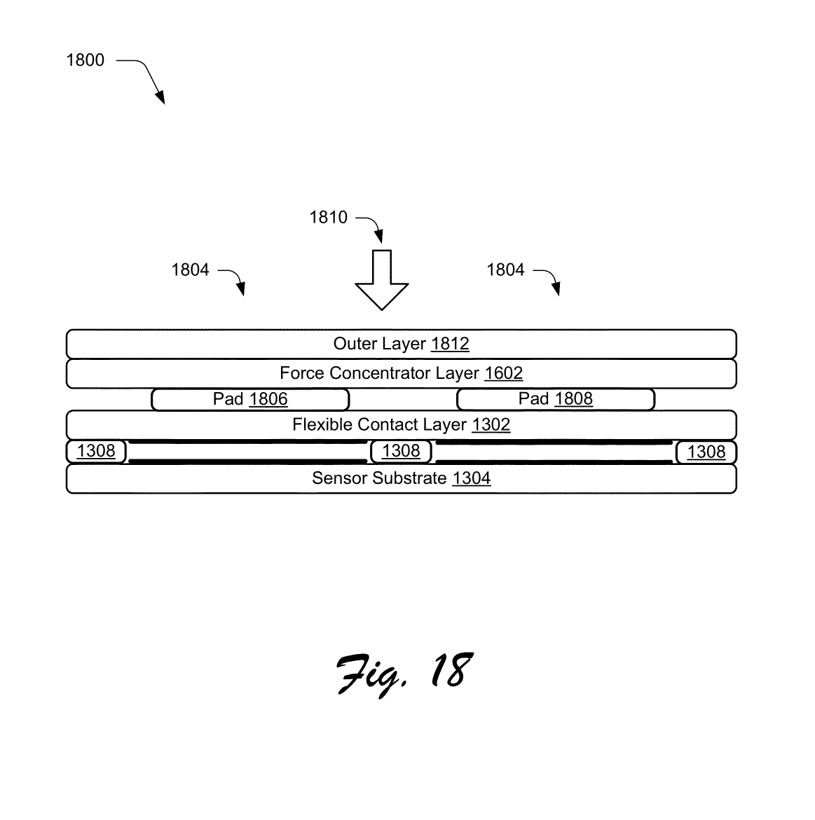

FIG. 18 illustrates an example of a view of a cross section of a keyboard 1800 that includes a plurality of pressure sensitive keys that employ the force concentrator layer. The keyboard 1800 in this example includes first and second pressure sensitive keys 1802, 1804. The pressure sensitive keys 1802, 1804 share a force concentrator layer 1602, a flexible contact layer 1302, a sensor substrate 1304, and a spacer layer 1308 as before. Each of the pressure sensitive keys 1802, 1804 in this example has a respective pad 1806, 1808 that is configured to channel pressure to cause contact between a respective portion of the flexible contact layer 1302 and sensor substrate 1304.

As previously described, limited flexibility at the edges of conventional pressure sensitive keys could result in an inability of the keys to recognize pressure applied at the edges of the keys. This could cause “dead zones” in which the input device 104 could not recognize applied pressures. However, through use of the force concentrator layer 1602 and channeling of pressure supported by the pads 1806, 1808 the existence of dead zones may be reduced and even eliminated.

For example, a location 1810 is illustrated through use of an arrow that is disposed between the first and second pressure sensitive keys 1802, 1804. In this instance, the location 1810 is disposed over the spacer layer 1308 and closer to the first pressure sensitive key 1802 than the second pressure sensitive key 1804.

Accordingly, the pad 1806 of the first pressure sensitive key 1802 may channel a greater amount of the pressure than the pad 1808 of the second pressure sensitive key 1804. This may result in a stronger signal being produce by the first pressure sensitive key 1802 than the second pressure sensitive key 1804, a signal being generated at just the first pressures sensitive key 1802 and not the second pressure sensitive key 1804, and so forth. Regardless, modules of the input device 104 and/or the computing device 102 may then determine a likely intent of a user regarding which of the keys is to be employed by processing the signals generated by the keys. In this way, the force concentrator layer 1602 may mitigate against dead zones located between the keys by increasing an area that may be used to activate the key through channeling.

The force concentrator layer 1602 may also be used to perform mechanical filtering of pressures applied against the keys. A user, for instance, when typing a document may choose to rest one or more fingers of a hand against a surface of the keys but not wish to activate the key. Without the force concentrator layer 1602, therefore, processing of inputs from the pressure sensitive keys may be complicated by determining whether an amount and/or duration of pressure applied to the key is likely intended to activate the key.

However, in this example the force concentrator layer 1602 may be configured for use with the flexible contact layer to mechanically filter inputs that are not likely to be intended by a user to activate the key. The force concentrator layer 1602, for instance, may be configured to employ a threshold that in combination with the flexible contact layer 1302 defines an amount of pressure to be employed to actuate the key. This may include an amount of pressure that is sufficient to cause the flexible contact layer 1302 and the force sensitive ink 1310 disposed thereon to contact conductors 1312 of the sensor substrate to generate a signal that is recognizable as an input by the input device 104 and/or computing device 102.

In an implementation, this threshold is set such that a pressure of approximately fifty grams or less is not sufficient to cause the force concentrator layer 1602 and the flexible contact layer 1302 to initiate the signal whereas pressures above that threshold are recognizable as inputs. A variety of other implementations and thresholds are also contemplated that may be configured to differentiate against a resting pressure and a key strike. For example, different parts may be configured to filter different amounts of pressures, such as to support accurate weighing on one part of the device while filtering for inadvertent inputs on another part of the device, e.g., for alphanumeric keys.

The force concentrator layer 1602 may also be configured to provide a variety of other functionality. The input device 104, for instance, may include an outer layer 912 (e.g., fabric, microfiber, and so on) on which indications of inputs of respective keys, e.g., letters, numbers, and other operations such as “shift,” “return,” navigation, and so on. The force concentrator layer 1602 may be disposed beneath this layer. Further, a side of the force concentrator layer 1602 that is exposed towards the outer layer 912 may be configured to be substantially smooth, thereby reducing and even eliminating witness lines that could result from underlying components of the input device 104.

In this way, a surface of the outer layer 912 may be made with increased uniformity and thus provided a better typing experience with increased accuracy, e.g., by promoting a smooth tactile feel without interference from underlying components. The force concentrator layer 1602 may also be configured to protect against electrostatic discharge (ESD) to underlying components of the input device 104. For example, the input device 104 may include a track pad as illustrated in FIGS. 1 and 2 and thus movement across the track pad may generate static. The force concentrator layer 1602, however, may protect components of the input device 104 that are exposed beneath the layer from this potential ESD. A variety of other examples of such protection are also contemplated without departing from the spirit and scope thereof.

FIG. 19 depicts a system 1900 in an example implementation in which multiple force concentrators are utilized. In this example, the input device base 214 includes the force concentrator that includes the force concentrator layer 1602 and pads 1806, 1808 of FIG. 18. The interchangeable surface 216 includes an outer layer 1812 that also includes a force concentrator.

The force concentrator of the interchangeable surface 216 includes a force concentrator layer 1902 and a bridge pad 1904. Accordingly, the bride pad 1904 may be used to cause pressure applied (e.g., a user's finger) through contact (e.g., against the outer layer 1812) to be channeled through the bridge pad to at least two pads (e.g., pads 1806, 1808) to initiate respective inputs. As the name implies the bridge pad 1904 of the force concentrator layer 1902 may bridge two or more keys of the keyboard in this example to initiate an input.

For instance, the bridge pad 1904 may be configured to cause an increase in a deformation bend radius of the force concentrator layer 1602 from that of a contact that applied pressure to the force concentrator layer 1902 that includes the bride pad 1904. Thus, in this example the force concentrator layer 1902 may support a mechanical mapping of indications of the interchangeable surface 216 to one or more corresponding sensors of the input device base 214.

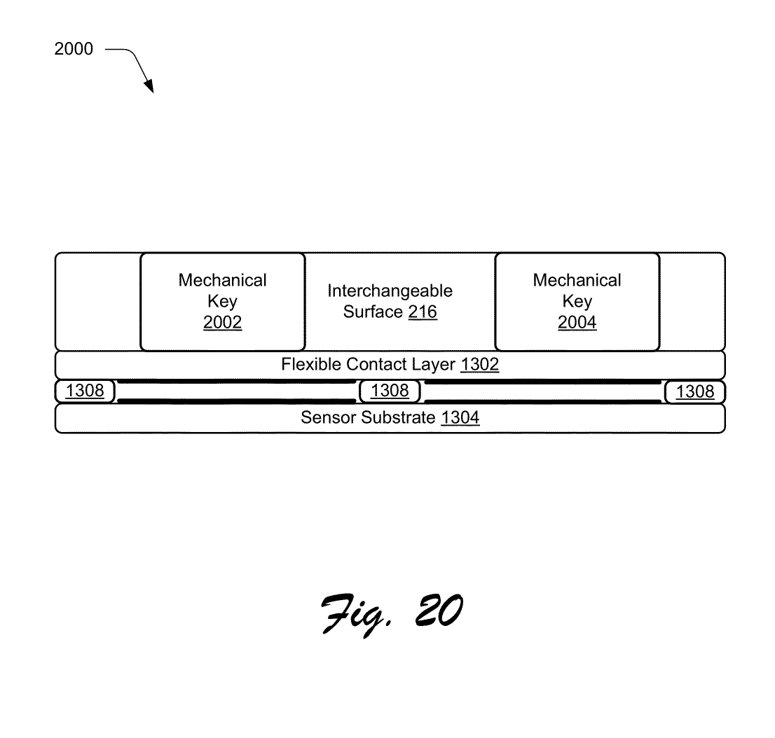

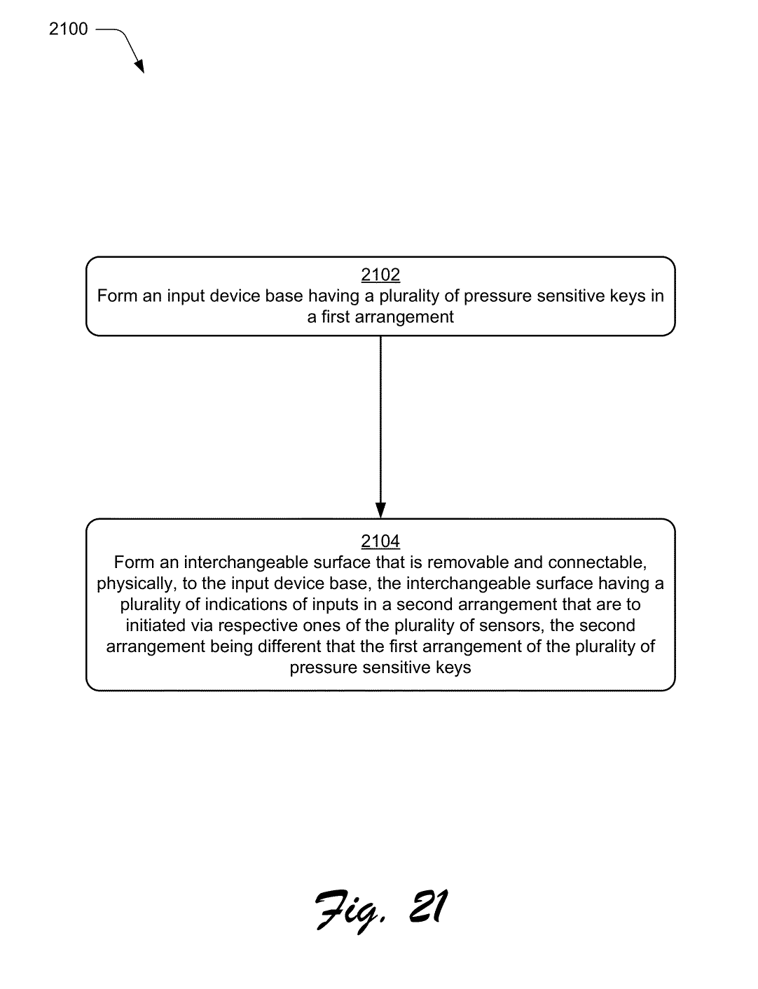

FIG. 20 depicts a system 2000 in an example implementation in which the interchangeable surface 216 is configured to include mechanical keys. In the previous example, the interchangeable surface 216 included mechanical functionality in the form of a force concentrator that is configured to direct pressure applied to the interchangeable surface 216. A variety of other examples of mechanical functionality may also be incorporated as part of the interchangeable surface.

For example, the interchangeable surface 216 may include mechanical keys 2002, 2004 that are configured to provide feedback in a manner similar to a traditional mechanical keyboard. Therefore, in this example the interchangeable surface 216 may include mechanicals keys (e.g., including mechanical plungers) to give a “mechanical feel” to pressure sensitive keys of the input device base 214 having the flexible contact layer 1302, sensor substrate 1304, and spacer layer 1308 as before. Thus, as described above the input device base 214 and the interchangeable surface 216 may be configured in a variety of ways to support a variety of different functionality, further discussion of which may be found in relation to the following procedures.

### Example Procedures

The following discussion describes interchangeable surface input device techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-20.

FIG. 21 depicts a procedure 2100 in an example implementation in which an input device having an input device base and interchangeable surface is formed. An input device base is formed having a plurality of pressure sensitive keys in a first arrangement (block 2102). The input device base 214, for instance, may be formed to include a plurality of sensors, such as pressure sensitive sensors, capacitive sensors, mechanical sensors, optical sensors, and so on. Further, the sensors may be configured to communicate a variety of different inputs, such as an X/Y coordinate, an amount or pressure, and so on. The input device base 214 may be configured to form a communicative coupling with a computing device 102, such as a computing device in a slate configuration through a physical (e.g., wired) or wireless connection.

An interchangeable surface is formed that is removable and connectable, physically, to the input device base. The interchangeable surface has a plurality of indications of inputs in a second arrangement that are to be initiated via respective ones of the plurality of sensors, the second arrangement being different that the first arrangement of the plurality of pressure sensitive keys (block 2104). A variety of different indications may be formed, such as keys having particular letters, numbers, and so on. Other indications may also be supported, such as game controls, sliders, radial dials, track pads, weighing portions (e.g., for packages in a shipping configuration), and so forth,

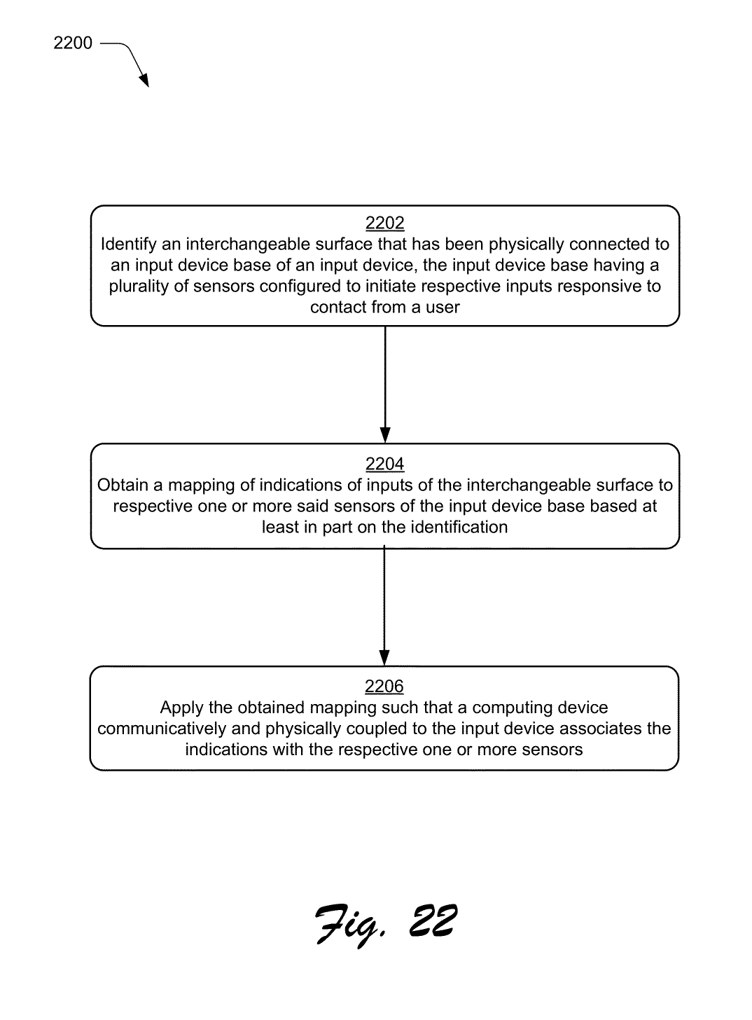

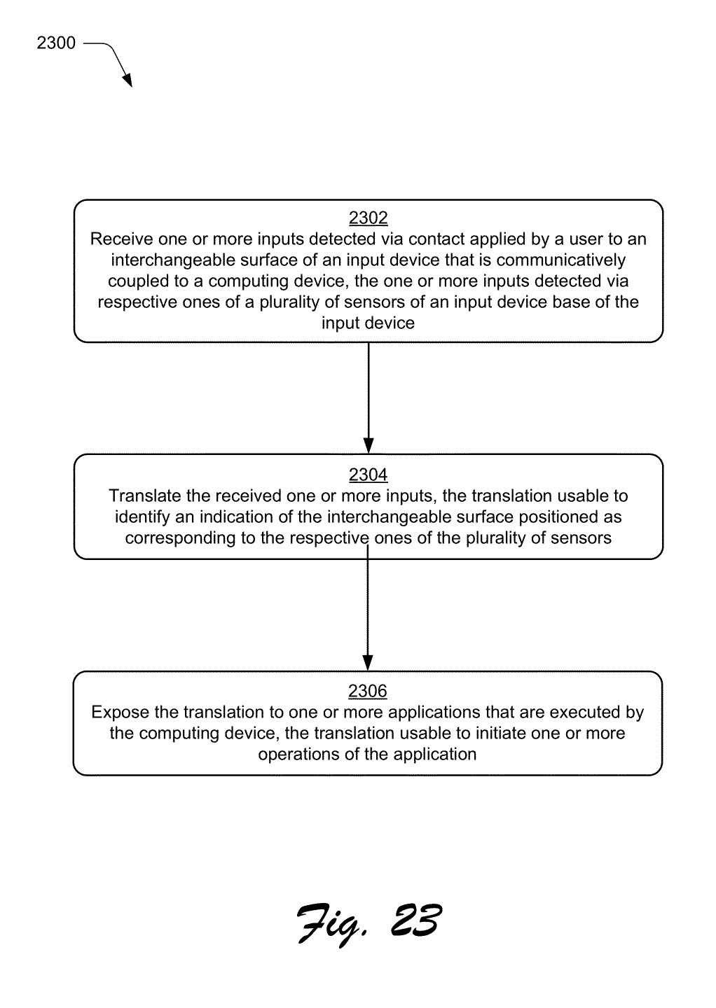

FIG. 22 depicts a procedure 2200 in an example implementation in which mappings are obtained that are usable to map indications of inputs of an interchangeable surface of an input device to corresponding sensors of an input device base. An interchangeable surface is identified that has been physically connected to an input device base of an input device, the input device base having a plurality of sensors configured to initiate respective inputs responsive to contact from a user (block 2202). The interchangeable surface, for instance, may be identified using magnetic, wired, optical, and/or mechanical techniques as previously described.

A mapping is obtained of indications of inputs of the interchangeable surface to respective one or more said sensors of the input device base based at least in part on the identifying (block 2204). The identifier, for instance, may be used to obtain mappings from a service provider, stored as part of an update locally by the computing device 102, and so on.

The obtained mapping is applied such that a computing device communicatively and physically coupled to the input device associates the indications with the respective one or more sensors (block 2206). The mappings may be applied by the interchangeable surface 216 itself, the input device base 214, and/or the computing device 102, e.g., by a driver, operating system, application, and so on.

FIG. 23 depicts a procedure 2300 in an example implementation in which input detected using an input device having an interchangeable surface are translated and exposed to an application of a computing device. One or more inputs are received that are detected via contact applied by a user to an interchangeable surface of an input device that is communicatively coupled to a computing device, the one or more inputs detected via respective ones of a plurality of sensors of an input device base of the input device (block 2302). The contact may originate in a variety of different ways by a user, such as from a finger of a user's hand, a stylus, placement of an object (e.g., for weighing purposes), and so on.

The received one or more inputs are translated, the translation usable to identify an indication of the interchangeable surface positioned as corresponding to the respective ones of the plurality of sensors (block 2304). The inputs, for instance, may be identified as corresponding to “what” is indicated by the interchangeable surface, such as a track pad, keys of a keyboard, controls of a game controller, and so forth.

The translation is exposed to one or more applications that are executed by the computing device, the translation usable to initiate one or more operations of the application (block 2306). The inputs, for instance, may be translated in accordance with an HID format, game controls, and so on such that the application may recognize the inputs. Further, the inputs may also indicate an amount of pressure that may also be translated, such as to aid interaction with a game, a music DJ configuration, and so forth. A variety of other examples are also contemplated without departing from the spirit and scope thereof.

### Example System and Device

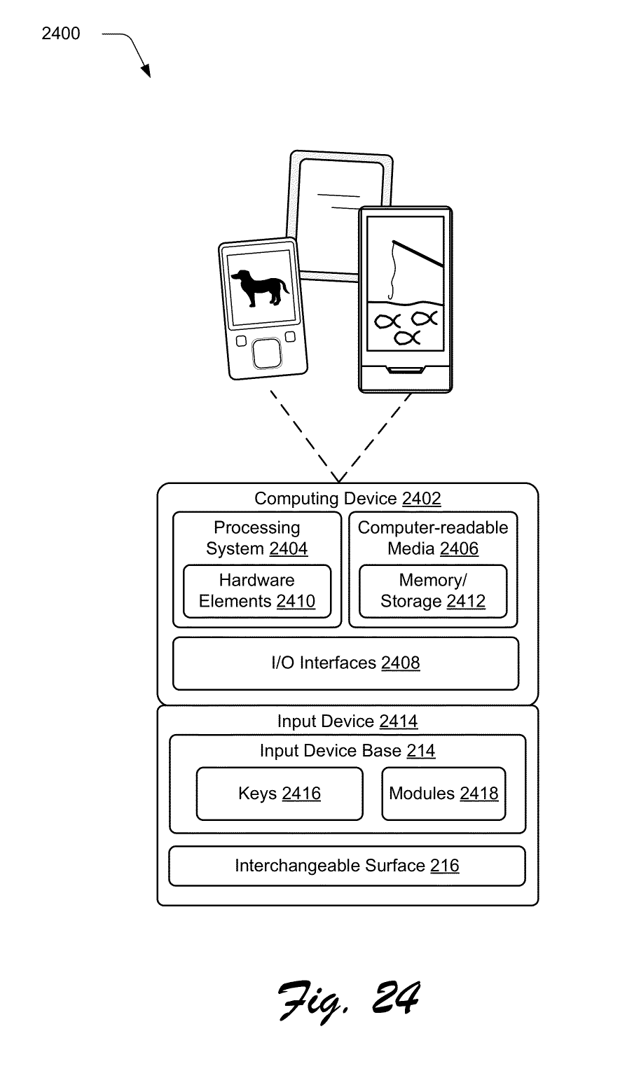

FIG. 24 illustrates an example system generally at 2400 that includes an example computing device 2402 that is representative of one or more computing systems and/or devices that may implement the various techniques described herein. The computing device 2402 may be, for example, be configured to assume a mobile configuration through use of a housing formed and size to be grasped and carried by one or more hands of a user, illustrated examples of which include a mobile phone, mobile game and music device, and tablet computer although other examples are also contemplated.

The example computing device 2402 as illustrated includes a processing system 2404, one or more computer-readable media 2406, and one or more I/O interface 2408 that are communicatively coupled, one to another. Although not shown, the computing device 2402 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 2404 is representative of functionality to perform one or more operations using hardware. Accordingly, the processing system 2404 is illustrated as including hardware element 2410 that may be configured as processors, functional blocks, and so forth. This may include implementation in hardware as an application specific integrated circuit or other logic device formed using one or more semiconductors. The hardware elements 2410 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 2406 is illustrated as including memory/storage 2412. The memory/storage 2412 represents memory/storage capacity associated with one or more computer-readable media. The memory/storage component 2412 may include volatile media (such as random access memory (RAM)) and/or nonvolatile media (such as read only memory (ROM), Flash memory, optical disks, magnetic disks, and so forth). The memory/storage component 2412 may include fixed media (e.g., RAM, ROM, a fixed hard drive, and so on) as well as removable media (e.g., Flash memory, a removable hard drive, an optical disc, and so forth). The computer-readable media 2406 may be configured in a variety of other ways as further described below.

Input/output interface(s) 2408 are representative of functionality to allow a user to enter commands and information to computing device 2402, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 2402 may be configured in a variety of ways to support user interaction.

The computing device 2402 is further illustrated as being communicatively and physically coupled to an input device 2414 that is physically and communicatively removable from the computing device 2402. In this way, a variety of different input devices may be coupled to the computing device 2402 having a wide variety of configurations to support a wide variety of functionality. In this example, the input device 2414 includes the input device base 214 and interchangeable surface 216 as before. The input device base 214 includes one or more keys 2416, which may be configured as pressure sensitive keys, mechanically switched keys, and other examples of sensors usable to detect contact or proximity, e.g., a capacitive sensor.

The input device 2414 is further illustrated as include one or more modules 2418 that may be configured to support a variety of functionality. The one or more modules 2418, for instance, may be configured to process analog and/or digital signals received from the keys 2416 to determine whether a keystroke was intended, determine whether an input is indicative of resting pressure, support authentication of the input device 2414 for operation with the computing device 2402, and so on.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 2402. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 2402, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 2410 and computer-readable media 2406 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 2410. The computing device 2402 may be configured to implement particular instructions and/or functions corresponding to the software and/or hardware modules. Accordingly, implementation of a module that is executable by the computing device 2402 as software may be achieved at least partially in hardware, e.g., through use of computer-readable storage media and/or hardware elements 2410 of the processing system 2404. The instructions and/or functions may be executable/operable by one or more articles of manufacture (for example, one or more computing devices 2402 and/or processing systems 2404) to implement techniques, modules, and examples described herein.

### CONCLUSION

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A method comprising:
identifying an interchangeable surface that has been physically connected to an input device base of an input device, the input device base having a plurality of sensors configured to initiate respective inputs;
obtaining a mapping of indications of inputs of the interchangeable surface to respective one or more said sensors of the input device base based at least in part on the identifying; and
applying the obtained mapping such that a computing device communicatively and physically coupled to the input device associates the indications with the respective one or more sensors.

2. A method as described in claim 1, wherein the identifying is based on an identifier stored as part of the interchangeable surface.

3. A method as described in claim 1, wherein the mapping is stored as part of the interchangeable surface.

4. A method as described in claim 1, wherein the obtaining of the mapping is performed by the computing device.

5. A method as described in claim 4, wherein the mapping is exposed for accessibility to the computing device via a network by a service provider.

6. A method as described in claim 1, wherein the plurality of sensors are configured as pressure sensitive sensors.

7. A method as described in claim 6, wherein the plurality of sensors are pressure sensitive sensors that are each configured to communicate different amounts of pressure as part of the respective inputs responsive to contact from a user.

8. A method as described in claim 6, wherein the mapping is configured to also map the different amounts of pressure for recognition by the computing device as part of respective said inputs.

9. A method as described in claim 1, wherein the mapping specifies that a single one of the indications corresponds to two or more respective said sensors.

10. A system comprising:
an input device comprising:
an input device base comprising a plurality of sensors configured to initiate respective inputs; and
an interchangeable surface that is removable and connectable, physically, to the input device base, the interchangeable surface having a plurality of indications of inputs that are to initiated via respective ones of the plurality of sensors and an identifier usable to identify a mapping corresponding to the input device; and
a computing device communicatively coupled to the input device, the computing device configured to initiate the inputs as indicated by the interchangeable surface responsive to contact from a user through utilization of the mapping.

11. A system as described in claim 10, wherein the plurality of sensors are pressure sensitive sensors.

12. A system as described in claim 11, wherein the plurality of sensors are pressure sensitive sensors that are each configured to communicate different amounts of pressure as part of the respective inputs responsive to contact from the user.

13. A system as described in claim 10, wherein the mapping is performed by the input device to expose the inputs as indicated by the interchangeable surface.

14. A system as described in claim 10, wherein the input device further comprises a connection portion configured to provide a physical and communicative coupling to the computing device, the computing device having a slate configuration.

15. A service provider implemented by one or more computing devices, the service provider configured to perform operations comprising exposing a mapping via a network to be obtained by a computing device, the mapping configured to cause the computing device to map indications of an interchangeable surface of an input device to respective one or more sensors of an input device base of the input device.

16. A service provider as described in claim 15, wherein the mapping is configured to map the plurality of sensors of the input device base as pressure sensitive sensors.

17. A service provider as described in claim 15, wherein the mapping is configured to configure the computing device to recognize different amounts of pressure of the pressure sensitive keys as part of the respective inputs responsive to contact from the user.

18. A service provider as described in claim 15, wherein the mapping specifies that a single one of the indications corresponds to two or more respective said sensors.

19. A service provider as described in claim 15, wherein the exposing is performed such that the mapping is locatable using an identifier stored as part of the interchangeable surface.

20. A service provider as described in claim 15, wherein the mapping is usable by an operating system of the computing device to expose the indicated inputs to one or more applications that are executable on the computing device.
